(19) United States
(12) Patent Application Publication
(10) Pub. No.: US 2016/0280216 A1
(43) Pub. Date: Sep. 29, 2016

(54) HYBRID VEHICLE

(71) Applicant: Fuji Jukogyo Kabushiki Kaisha, Tokyo (JP)

(72) Inventor: Atsushi DOUKI, Tokyo (JP)

(21) Appl. No.: 15/060,440

(22) Filed: Mar. 3, 2016

(30) Foreign Application Priority Data
Mar. 23, 2015 (JP) 2015-060132

(51) Int. Cl. B60W 20/20; B60W 10/06; B60W 10/08; B60K 6/442; B60K 6/52

(52) U.S. Cl. CPC B60W 20/20; B60K 6/442; B60K 6/52; B60W 10/08; B60W 10/06; Y10S 903/93; B60Y 2200/92; B60Y 2200/20; B60Y 2300/182; B60Y 2300/188; B60W 2550/14

(57) ABSTRACT

A hybrid vehicle travels by a driving force of either one or both of an engine and an electric motor. The hybrid vehicle includes a traveling mode switching module that switches among a plurality of traveling modes including a motor traveling mode in which the vehicle travels by the motor prior to the engine and an engine and motor combined traveling mode in which the vehicle travels using both the motor and the engine, and a condition determining module that determines whether a bad road condition defined in advance is met. If it is determined that the bad road condition is met, the traveling mode switching module causes the engine to start regardless of the traveling mode at the time when the engine is stopped, and prohibits a stop of the engine while the bad road condition is met.

### CROSS-REFERENCE TO RELATED APPLICATION

The present application claims priority from Japanese Patent Application No. 2015-060132 filed on Mar. 23, 2015, the entire contents of which are hereby incorporated by reference.

### BACKGROUND

1. Technical Field

The present disclosure relates to a hybrid vehicle having two power sources, an engine and an electric motor.

2. Related Art

Currently, hybrid vehicles having two power sources, an engine and an electric motor, spread widely. For example, as disclosed in International Publication (WO-A1) No. 2012/127674, such hybrid vehicles are provided with a motor traveling mode in which the vehicle travels by the motor prior to the engine when a residual quantity of a battery is sufficient, and a traveling mode called an engine and motor combined traveling mode in which the motor and the engine are used together when the residual quantity of the battery is low. For example, in the hybrid vehicle, the traveling mode is selected according to the residual quantity of the battery. When the engine and motor combined traveling mode is selected, an operating state of the engine and an operating state of the motor are switched according to the traveling state to improve an energy efficiency. Therefore, it is possible to reduce emission of CO₂, etc.

Moreover, plug-in hybrid vehicles (PHEVs) have also been proposed, which can directly charge electrical energy (used for the hybrid vehicles described above) from a commercial electric socket. The PHEVs generally have a larger capacity of the battery compared with hybrid vehicles other than the PHEVs. Therefore, the PHEVs can travel a longer distance in the motor traveling mode.

In addition, some automobiles, such as the plug-in hybrid vehicles, are possible to change a driving state between four-wheel drive (4WD) traveling in which both front and rear wheels are driven, and two-wheel drive (2WD) traveling in which only front or rear wheels are driven. The driving state of 4WD traveling and 2WD traveling can be switched according to the traveling state (i.e., part-time 4WD traveling etc.). For example, if it is determined that a switching to 4WD traveling is required, the engine is started in advance.

### SUMMARY OF THE INVENTION

However, the hybrid vehicle described above selects between the motor traveling mode and the engine and motor combined traveling mode, for example, according to the residual quantity of the battery of the vehicle, regardless of an environment outside the vehicle. Therefore, the motor traveling mode may be selected also while traveling on a so-called bad road (including off-road) when traveling a mountain path or crossing a creek. If the engine is stopped while the hybrid vehicle is crossing the creek etc., water enters from an exhaust pipe (muffler), and the engine may be damaged by a so-called water hammer.

It is desirable to provide a hybrid vehicle, which can avoid a damage to an engine regardless of an environment outside the vehicle.

An aspect of the present disclosure provides a hybrid vehicle that travels by a driving force of either one or both of an engine and an electric motor is provided. The hybrid vehicle includes a traveling mode switching module that switches among a plurality of traveling modes including a motor traveling mode in which the vehicle travels by the motor prior to the engine and an engine and motor combined traveling mode in which the vehicle travels using both the motor and the engine, and a condition determining module that determines whether a bad road condition defined in advance is met. If it is determined that the bad road condition is met, the traveling mode switching module causes the engine to start regardless of the traveling mode at the time when the engine is stopped, and prohibits a stop of the engine while the bad road condition is met.

The hybrid vehicle may further include a drive switching module that switches according to a traveling state of the vehicle, between 2WD traveling in which either one of front wheels and rear wheels are driven and 4WD traveling in which both the front wheels and the rear wheels are driven. The drive switching module may select 4WD traveling while the bad road condition is met, and select a comparatively high engaging rate among a plurality of engaging rates of coupling for 4WD traveling.

The bad road condition may be that a vehicle operator turns on a switch. The bad road condition may be that water equal to or more than a predetermined water depth exists at a position of the vehicle.

The hybrid vehicle may further include a traveling environment recognizing module that recognizes a traveling environment outside the vehicle based on one or more images imaged by one or more imaging devices. The bad road condition may be that water equal to or more than a predetermined water depth exists at a traveling position ahead of the vehicle under the traveling environment.

### BRIEF DESCRIPTION OF THE DRAWINGS

The present disclosure is illustrated by way of example and not by way of limitation in the figures of the accompanying drawings, in which like reference numerals indicate like elements and in which:

FIG. 1 is a view illustrating a configuration of a hybrid vehicle; and

FIG. 2 is a flowchart illustrating a traveling processing by a controller.

### DETAILED DESCRIPTION

Hereinafter, a suitable implementation of the present disclosure is described in detail with reference to the accompanying drawings. Dimensions, materials, concrete numerical values, etc. illustrated in this implementation are merely illustrations for easier understandings of the present disclosure, and are not to be intended to limit the present disclosure, unless otherwise particularly described. Note that in this specification and the accompanying drawings, components having substantially the same functions and configurations are denoted with the same reference numerals and, thus, redundant descriptions are omitted. Further, illustrations of components which are not directly related to the present disclosure are omitted.

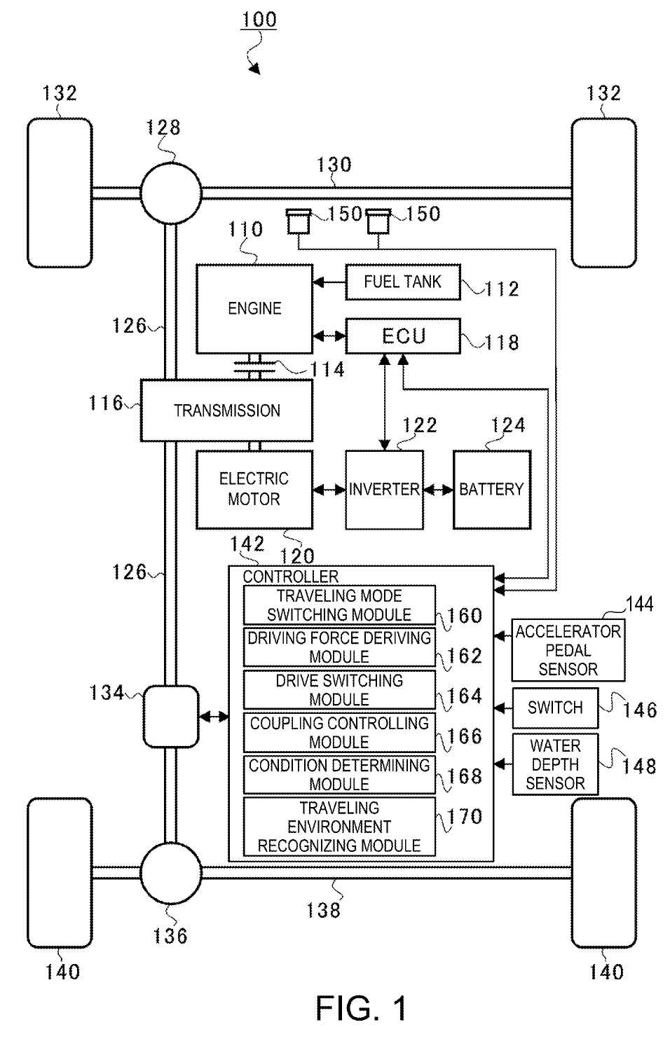

FIG. 1 is a view illustrating a configuration of a hybrid vehicle 100. The hybrid vehicle 100 is possible to change a driving state between four-wheel drive (4WD) traveling in which both front wheels and rear wheels are driven and two-wheel drive (2WD) traveling in which either front or rear wheels are driven. The hybrid vehicle 100 includes an engine 110, a fuel tank 112, a clutch 114, a transmission 116, an engine control unit (hereinafter, simply referred to as “ECU”) 118, an electric motor 120, an inverter 122, a battery 124, a propeller shaft 126, a front differential 128, a drive shaft 130, front wheels 132, an electronic-control coupling 134, a rear differential 136, a drive shaft 138, rear wheels 140, a controller 142, an accelerator pedal sensor 144, a switch 146, a water depth sensor 148, and imaging devices 150.

This implementation describes especially about a plug-in hybrid vehicle (PHEV) which can directly charge electrical energy from a commercial electric socket, as the hybrid vehicle 100. Here, configurations related to features of this implementation will be described in detail, but description about configurations unrelated to the features of this implementation will be omitted.

The engine 110 is comprised of a gasoline engine or a diesel engine. The engine 110 combusts fuel (gasoline, diesel fuel, etc.) supplied from the fuel tank 112 to obtain a driving force, and the obtained driving force is transmitted to the transmission 116 via the clutch 114. The engine 110 is coupled to the ECU 118 and the driving force is adjusted based on a control command from the ECU 118.

The motor 120 is disposed coaxially with the engine 110. The motor 120 obtains a driving force by electric power supplied from the battery 124 via the inverter 122, and the obtained driving force is transmitted to the transmission 116. In addition, the motor 120 also functions as a power generator which operates when the electric power is not supplied, and generated electric power is accumulated in the battery 124 via the inverter 122. The inverter 122 is coupled to the ECU 118, and the supplied power (i.e., the driving force of the electric motor 120) is adjusted based on a control command of the ECU 118.

The driving force obtained from the engine 110 or the electric motor 120 is transmitted to the propeller shaft 126 by the transmission 116 after a torque, a rotational speed and a rotational direction are adjusted, and is further transmitted to the front wheels 132 via the front differential 128 and the drive shaft 130. Then, in 4WD traveling, the driving force outputted from the transmission 116 is also transmitted to the rear wheels 140 via the electronic-control coupling 134, the rear differential 136, and the drive shaft 138. In this implementation, the front wheels 132 directly acquire the drive force from the transmission 116 while the rear wheels 140 acquire the driving force via the electronic-control coupling 134. Alternatively, the drive force may be directly transmitted to the rear wheels 140 from the transmission 116 while the driving force may be transmitted to the front wheels 132 via the electronic-control coupling 134.

The controller 142 is comprised of a semiconductor integrated circuit containing one or more central processing units (CPUs), one or more ROMs which stores one or more programs etc., one or more RAMs as work areas, etc. The controller 142 integrally controls the entire hybrid vehicle 100. In addition, the controller 142 also functions in this implementation as a traveling mode switching module 160, a driving force deriving module 162, a drive switching module 164, a coupling controlling module 166, a condition determining module 168, and a traveling environment recognizing module 170. The controller 142 is also coupled to to the accelerator pedal sensor 144, the switch 146, the water depth sensor 148, and the imaging devices 150. The accelerator pedal sensor 144 detects a stepping amount of an accelerator pedal (not illustrated) by a vehicle operator. The switch 146 detects an operational input (ON/OFF) by the operator. The water depth sensor 148 detects a depth of water when the vehicle is located in the water. Each imaging device 150 is comprised of image sensors, such as CCDs (Charge-Coupled Devices) or CMOSs (Complementary Metal-Oxide Semiconductors). The imaging device 150 images a view forward of the hybrid vehicle 100 and is capable of generating a monochrome image or a color image. A pair of imaging devices 150 is provided, and is disposed so as to be separated from each other substantially in horizontal directions so that their optical axes are oriented substantially parallel and toward a traveling direction of the hybrid vehicle 100. The controller 142 also controls the driving force of the engine 110 or the electric motor 120 via the ECU 118.

### Switching of Traveling Mode

The hybrid vehicle 100 is provided, as a traveling mode, with a motor traveling mode in which the vehicle travels by the motor 120 prior to the engine 110 when a residual quantity of the battery 124 is sufficient, and an engine and motor combined traveling mode in which the motor 120 and the engine 110 are used together when the residual quantity of the battery 124 is low (e.g., when the residual quantity of the battery 124 is reduced after traveling in the motor traveling mode). The traveling mode switching module 160 switches the traveling mode according to a traveling state at the time. However, in this implementation, the engine 110 may be temporarily started during the motor traveling mode as will be described later.

In such a plug-in hybrid vehicle of this implementation, electric power is charged into the battery 124 in advance from a commercial electric socket taking advantage of less-expensive nighttime power etc., and the charged electric power is first consumed when the vehicle travels. Therefore, the traveling mode switching module 160 selects the motor traveling mode when the vehicle starts traveling. Since the plug-in hybrid vehicle generally has a larger capacity of the battery 124 compared with other hybrid vehicles, it is possible to travel a longer distance in the motor traveling mode. Here, the traveling mode switching module 160 prevents the engine 110 from turning into a rotational load by disengaging the clutch 114. Further, in any one of the traveling modes, when a brake is operated or the accelerator pedal is released, the motor 120 is used as the generator to collect regenerative energy.

If the residual quantity of the battery 124 becomes low, the traveling mode switching module 160 switches the traveling mode to the engine and motor combined traveling mode from the motor traveling mode to maintain the vehicle traveling. In such an engine and motor combined traveling mode, since the driving force of any one of the engine 110 and the motor 120 can be used, a smoother and more powerful travel is possible compared with a case where the engine 110 is operated alone. Although a large torque is difficult to obtain from the engine 110 in a low engine speed range, the motor 120 drives the vehicle prior to the engine in such a low engine speed range. Thus, a response is improved, and a smooth and efficient start is possible. If the residual quantity of the battery 124 is lowered below a predetermined value, the traveling mode switching module 160 uses the motor 120 as the generator to accumulate power in the battery 124 with the driving force of the engine 110.

### Operation of Controller 142

The hybrid vehicle 100 can be set so that the vehicle travels while switching between 2WD traveling and 4WD traveling. However, while traveling in 2WD traveling, if a large driving force is applied (or demanded), a load is applied only to the driving wheels of 2WD traveling (i.e., either only to front wheels or only to rear wheels), and components of a drive system may be damaged. On the other hand, if 4WD traveling is always used in order to spread the driving force, driving power is always consumed by the electronic-control coupling 134 during the traveling to consume the battery 124. Therefore, power which is available for traveling decreases to affect the traveling distance. Thus, as will be described below, 2WD traveling and 4WD traveling are efficiently switched to avoid the damage to the components of the drive system and reduce the power consumption.

The driving force deriving module 162 acquires the stepping amount of the accelerator pedal detected by the accelerator pedal sensor 144, and derives a demanded driving force by the operator.

In a case where the traveling mode at the time is the motor traveling mode, the traveling mode switching module 160 forcibly starts the engine 110 while maintaining the motor traveling mode, if the driving force derived by the driving force deriving module 162 is equal to or larger than a predetermined drive threshold. Thus, since the engine 110 is started, the driving force of the engine 110 can be obtained in addition to the driving force of the motor 120, it is possible to meet the demanded driving force of the operator. The drive threshold can be any value determined according to experiments or actual traveling.

Here, the engine 110 is started in the motor traveling mode when the driving force derived by the driving force deriving module 162 becomes equal to or larger than the predetermined drive threshold, but the engine 110 will not be stopped immediately even if the driving force is dropped below the predetermined drive threshold. This is because the fuel consumption of the engine 110 can be improved when the operating state of the engine 110 is maintained for a certain amount of time, rather than a start and a stop of the engine 110 are repeated within a short period of time. Therefore, the traveling mode switching module 160 stops the engine 110 only when the driving force becomes below the drive threshold and a predetermined engine stopping condition is met (hysteresis characteristics). Here, the predetermined engine stopping condition includes, for example, a predetermined period of time being lapsed after the engine 110 is started, a temperature of the engine 110 meeting a predetermined temperature condition, the residual quantity of the battery 124 equal to or above the predetermined value, etc.

The drive switching module 164 can switch between 2WD traveling and 4WD traveling. In a case where the traveling mode at the time is the motor traveling mode, if the driving force derived by the driving force deriving module 162 is below the predetermined drive threshold, 2WD traveling is selected, and if the driving force derived by the driving force deriving module 162 is equal to or larger than the predetermined drive threshold, 4WD traveling is selected. Therefore, if the driving force derived by the driving force deriving module 162 is equal to or larger than the predetermined drive threshold, the engine 110 can be started at least in the driving state shifted to 4WD traveling. Note that, as for the order of execution of the switching processing to 4WD traveling and the starting processing of the engine 110, it is desirable to first perform the switching processing to 4WD traveling in terms of the protection of the components. Further, when the traveling mode is the engine and motor combined traveling mode, the drive switching module 164 maintains 4WD traveling associated with the maintaining of the operating state of the engine 110.

The coupling controlling module 166 drives a driving solenoid of the electronic-control coupling 134 during 4WD traveling, and adjusts a duty ratio between the front wheels 132 and the rear wheels 140 according to the traveling state to perform an optimal transmission of the driving force to the rear wheels 140.

Here, as described above, the traveling mode switching module 160 switches the traveling mode according to the traveling state at the time, and the engine 110 is then started in the motor traveling mode when the operator demands a high driving force. However, since the switching of the traveling mode and the starting or not starting of the engine 110 are controlled independently from an environment outside the vehicle, the engine 110 may be stopped after the motor traveling mode is selected, for example, during traveling on a so-called bad road, such as traveling on a mountain path or crossing a creek. If so, when the hybrid vehicle is crossing the creek etc., water enters into the engine 110 from an exhaust pipe (muffler) when the engine 110 is stopped and, thus, the engine 110 may be damaged by a so-called water hammer. Thus, one purpose of this implementation is to avoid the damage of the engine 110 regardless of the environment outside the vehicle.

The hybrid vehicle 100 of this implementation is also provided with a special traveling mode (bad road traveling mode) in order to address the traveling on the bad road. The traveling mode can be switched into the bad road traveling mode by meeting a bad road condition defined in advance. The bad road condition includes the switch 146 being turned on by the operator, for example. Therefore, when the operator expects to travel on the bad road later, the operator himself/herself operates (turns on) the switch 146 to switch the traveling mode to the bad road traveling mode.

Thus, when the switch 146 is turned on, the condition determining module 168 determines that the bad road condition is met in response to the operation of the switch 146, and the traveling mode switching module 160 then switches the traveling mode to the bad road traveling mode. When the engine 110 is stopped, the engine 110 is started and a stop of the engine 110 is prohibited (the driving by the engine 110 is maintained) while the bad road condition is met (i.e., while the switch 146 is on). When the switch 146 is turned on and the traveling mode is switched to the bad road traveling mode, the drive switching module 164 switches to 4WD traveling if the current driving state is 2WD traveling to perform 4WD traveling while the switch 146 is on. A comparatively high engaging rate (here, the highest engaging rate) is selected among a plurality of engaging rates of the coupling (clutch) for 4WD traveling to obtain the maximum torque which is transmitted to the rear wheels 140. Note that comparatively low engaging rates among the plurality of engaging rates are used when the driving state is 4WD traveling in the motor traveling mode or the engine and motor combined traveling mode.

As described above, the engine 110 is operated in 4WD traveling while the bad road condition is met (while the condition determining module 168 determines that the bad road condition is met), even if the front wheels 132 or the rear wheels 140 slip on the bad road, such as a snowy road or the mountain path, the vehicle is possible to escape smoothly from the bad road because a large driving range can be appropriately applied to the driving forces acting on the respective wheels. Further, even if the vehicle travels a downward slope etc. of the snowy road or a gravel road, the operator is possible to travel down the slope while maintaining the vehicle speed within a predetermined speed range, without having his/her attention caught by a braking operation.

Further, since the stop of the engine 110 is prohibited while the bad road condition is met, the engine 110 is kept operated and, thus, water will not enter from the exhaust pipe. Therefore, the engine 110 will not be damaged by the so-called water hammer.

Further, when the vehicle travels the bad road in the motor traveling mode, the state where only the motor 120 drives and the state where both the motor 120 and the engine 110 drive are switched frequently according to a change in the demanded driving force.

Therefore, output variations at the switching timings may affect a comfortable traveling (because energy is used for starting the engine 110). However, in this implementation, the engine 110 is started in advance and the engine operating state is then maintained. Therefore, even if the demanded driving force during the traveling on the bad road is changed, it is possible to minimize the output variation because the driving force is always compensated by the output from the engine 110. For example, if traveling on a step-like bad road, a delicate adjustment of the output is normally required. However, since the output of the engine 110 solves everything, the output variation can be controlled. Thus, the driving force follows linearly the opening of the accelerator (pedal).

Further, even when the demanded driving force increases and the output of the engine 110 is needed, the engine 110 has been operated in advance. Therefore, it is not necessary to wait for a start of the engine 110 each time and, thus, it is possible to improve a response until the vehicle demonstrates its maximum potential driving force.

In the above, although a turn-on of the switch 146 by the operator is described as one example of the bad road condition, this condition may also include, without limiting to the example, a situation where water may enter from the exhaust pipe (particularly, water equal to or more than a predetermined water depth (e.g., 20 cm) exists at the position of the vehicle). In such a case, the water depth sensor 148 detects the depth of water. If the depth of water is equal to or more than the predetermined water depth, the condition determining module 168 determines that the bad road condition is met. If the engine 110 is stopped, the traveling mode switching module 160 causes the engine 110 to start, and prohibits the stop of the engine 110 while the depth of water is equal to or more than the predetermined water depth.

Alternatively, the vehicle being located in the water equal to or more than the predetermined water depth may be detected by other methods. For example, the traveling environment recognizing module 170 which recognizes a traveling environment outside the vehicle based on the images imaged by the imaging devices 150 may be used for the detection. In such a case, the traveling environment recognizing module 170 detects that water equal to or more than the predetermined water depth at a traveling position ahead of the vehicle, as described below.

Specifically, the hybrid vehicle 100 of this implementation uses the imaging devices 150 to image a situation ahead of the hybrid vehicle 100, and recognizes the traveling environment outside the vehicle based on color information and positional information of the imaged images. Here, the traveling environment indicates total environmental information including a state of a road, a state of buildings located outside the road, a state of other vehicles traveling on the road or crossing the road, a state of pedestrians moving, etc. ahead of the hybrid vehicle 100, according to the traveling of the hybrid vehicle 100. The traveling environment recognizing module 170 identifies based on the traveling environment, that the road surface is a “water surface,” if the road surface ahead of the vehicle meets a predetermined condition defined in advance which corresponds to the “water surface” (e.g., it is a plane and has a higher light reflectivity than the road surface). Then, the depth of water is estimated according to the size of the water surface, and a spatial relationship with three-dimensional objects standing to the side of the water surface.

As described above, if the traveling environment recognizing module 170 estimates that the depth of water is equal to or more than the water depth, the condition determining module 168 determines that the bad road condition is met. Then, if the engine 110 is stopped, the traveling mode switching module 160 causes the engine 110 to start, and prohibits a stop of the engine 110 while the depth of water being equal to or more than the water depth is estimated.

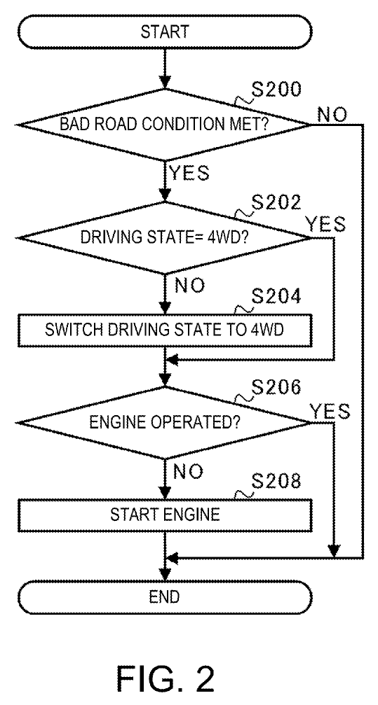

FIG. 2 is a flowchart illustrating a traveling processing by the controller 142. First, the condition determining module 168 determines whether the bad road condition is met (S200), e.g., whether the switch 146 is turned on by then operator. Here, if the bad road condition is not met (NO at S200), the traveling processing concerned is ended in order to perform a suitable control according to the traveling mode at the time. On the other hand, if the bad road condition is met (YES at S200), the following processings will be executed.

Specifically, the drive switching module 164 determines whether the current driving state is 4WD traveling (S202), and if it is not 4WD traveling (NO at S202), it is switched to 4WD traveling (S204). Here, the coupling controlling module 166 drives the electronic-control coupling 134 to perform an optimal driving-force transmission to the rear wheels 140 according to the traveling state. On the other hand, if the current driving state is 4WD traveling (YES at S202), 4WD traveling is maintained. Then, the traveling mode switching module 160 determines whether the engine 110 is currently operated (S206). If the engine 110 is not operated (NO at S206), the engine 110 is started (S208). On the other hand, if the engine 110 has already been operated (YES at S206), a stop of the engine 110 is prohibited and the engine operating state is maintained. Here, the traveling mode switching module 160 maintains the prohibiting state of the stop of the engine 110 while the condition determining module 168 determines that the bad road condition is met.

As described above, according to the hybrid vehicle 100 of this implementation, since the traveling mode switching module 160 prohibits a stop of the engine 110 if the condition determining module 168 determines that the bad road condition is met regardless of the environment outside the vehicle, water will not enter from the exhaust pipe. In addition, since the engine 110 is operated in advance, the driving force of the engine 110 always compensates the variation in the demanded driving force when traveling on the bad road. Therefore, the output variation can be minimized, and it is not necessary to wait for a start of the engine 110 each time and, thus, it is possible to improve a response until the vehicle demonstrates the maximum potential driving force.

Alternatively, the algorithms described above may also be provided as one or more programs which cause one or more computers to operate as the controller 142, or one or more storage media which record the program(s) and are readable by the computer(s), such as one or more flexible discs, magneto-optical discs, ROMs, CDs, DVDs, BDs. The term “program” as used herein refers to a data set which is described in any languages and any describing methods.

As described above, although a suitable implementation of the present disclosure is described with reference to the accompanying drawings, the present disclosure is not limited to this implementation. It is apparent to a person skilled in the art that he/she can arrive at various kinds of modifications and changes of the implementation, and it is understood that those modifications and changes naturally belong to a technical scope of the present disclosure within the scope of the appended claims.

Note that it is not necessary to sequentially process the traveling processing of this specification in accordance with the order illustrated as the flowchart, and the processing may also include parallel processings or subroutines.

The present disclosure can be utilized for hybrid vehicles having two power sources, an engine and an electric motor.

1. A hybrid vehicle that travels by a driving force of either one or both of an engine and an electric motor, the hybrid vehicle comprising:
a traveling mode switching module that switches among a plurality of traveling modes including a motor traveling mode in which the vehicle travels by the motor prior to the engine and an engine and motor combined traveling mode in which the vehicle travels using both the motor and the engine; and
a condition determining module that determines whether a bad road condition defined in advance is met,
wherein, if it is determined that the bad road condition is met, the traveling mode switching module causes the engine to start regardless of the traveling mode at the time when the engine is stopped, and prohibits a stop of the engine while the bad road condition is met.

2. The hybrid vehicle of claim 1, further comprising a drive switching module that switches according to a traveling state of the vehicle, between two-wheel drive traveling in which either one of front wheels and rear wheels are driven and four-wheel drive traveling in which both the front wheels and the rear wheels are driven, wherein the drive switching module selects four-wheel drive traveling while the bad road condition is met, and selects a comparatively high engaging rate among a plurality of engaging rates of coupling for four-wheel drive traveling.

3. The hybrid vehicle of claim 1, wherein the bad road condition is that a vehicle operator turns on a switch.

4. The hybrid vehicle of claim 2, wherein the bad road condition is that a vehicle operator turns on a switch.

5. The hybrid vehicle of claim 1, wherein the bad road condition is that water equal to or more than a predetermined water depth exists at a position of the vehicle.

6. The hybrid vehicle of claim 2, wherein the bad road condition is that water equal to or more than a predetermined water depth exists at a position of the vehicle.

7. The hybrid vehicle of claim 1, further comprising a traveling environment recognizing module that recognizes a traveling environment outside the vehicle based on one or more images imaged by one or more imaging devices, wherein the bad road condition is that water equal to or more than a predetermined water depth exists at a traveling position ahead of the vehicle under the traveling environment.

8. The hybrid vehicle of claim 2, further comprising a traveling environment recognizing module that recognizes a traveling environment outside the vehicle based on one or more images imaged by one or more imaging devices, wherein the bad road condition is that water equal to or more than a predetermined water depth exists at a traveling position ahead of the vehicle under the traveling environment.
